(19) United States
(12) Patent Application Publication
(10) Pub. No.: US 2026/0149369 A1
(43) Pub. Date: May 28, 2026

(54) EXPANDING VOLTAGE GAIN RANGE OF CLLC RESONANT CONVERTERS VIA SOFT-MORPHING TECHNIQUE

(71) Applicants: Lite-On Singapore Pte Ltd, Singapore (SG); Nanyang Technological University, Singapore (SG)

(72) Inventors: Ziheng Xiao, Singapore (SG); Yi Tang, Singapore (SG); Lei Zhang, Singapore (SG); Fei Deng, Singapore (SG); Zhigang Yao, Singapore (SG); Jing Yang, Singapore (SG); Shih-Ming Chen, Taipei (TW); Yi Chyn Cassandra Wong, Singapore (SG)

(73) Assignees: Lite-On Singapore Pte Ltd, Singapore (SG); Nanyang Technological University, Singapore (SG)

(21) Appl. No.: 19/235,630

(22) Filed: Jun. 12, 2025

Related U.S. Application Data
(60) Provisional application No. 63/724,500, filed on Nov. 25, 2024.

(51) Int. Cl. H02M 3/00; H02M 1/00; H02M 3/335

(52) U.S. Cl. CPC H02M 3/01; H02M 1/0058; H02M 3/33573

(57) ABSTRACT

CLLC resonant converters using full-bridge (FB) and half-bridge (HB) soft-morphing techniques are disclosed. Two forms of soft-morphing are provided: type1, steady-state rotational soft-morphing, which ensures balanced power loss and thermal stress across all power switches, and type2, dynamic soft-morphing, which facilitates smooth transitions between FB-FB, FB-HB, and HB-FB modes. Consequently, the FB CLLC resonant converter can achieve a 16× ultra-wide voltage gain range.

### CROSS-REFERENCE TO RELATED APPLICATION

This application claims the priority benefit of U.S. provisional application Ser. No. 63/724,500, filed on Nov. 25, 2024. The entirety of the above-mentioned patent application is hereby incorporated by reference herein and made a part of this specification.

### BACKGROUND

### Technical Field

The disclosure relates to a resonant converter, and in particular to a CLLC resonant converter.

### Description of Related Art

The CLLC resonant converter is a type of resonant converter that has gained significant attention in power electronics for its ability to achieve high efficiency and reduced power loss. This converter topology is particularly well-suited for applications requiring efficient power conversion, such as renewable energy systems, electric vehicle chargers, and data centers. Expanding the voltage gain range in various operating scenarios while preserving the high efficiency of CLLC resonant converters is crucial yet challenging. In electric vehicle (EV) charging systems, the battery voltage can vary significantly, typically ranging from 250 V to 800 V. To accommodate different types of EV batteries, converters are often designed to operate over an even broader range, from 150 V to 920 V. This wide operational range is essential for ensuring compatibility with a diverse array of battery chemistries and capacities, which is fundamental for the widespread adoption of EVs. Achieving this requires innovative design and control strategies to maintain high efficiency across the entire voltage range, ensuring that power conversion remains effective and reliable under varying load and input conditions.

Several methods have been proposed to achieve a wider voltage gain range, with topology morphing techniques allowing for natural expansion without inducing higher resonant currents. Topology morphing involves changing the topology configuration during operation. For instance, full-bridge (FB) inverters and stacked structure inverters, which offer various operational modes, are extensively utilized in applications requiring a wide voltage gain range. However, this approach presents several challenges. Significant switching frequency variations between different modes can lead to large voltage spikes unless the transition sequence is carefully managed. In cases where an FB inverter operates in a half-bridge (HB) manner, the power losses across the four switches become unbalanced. Specifically, one bridge operates at high frequency (HF), while the other remains idle. The HF switches experience both switching and conduction losses, while the idle switches incur only conduction losses. This results in imbalanced thermal stress, ultimately reducing the converter's lifespan. Addressing these challenges requires sophisticated control strategies to ensure smooth transitions and balanced thermal management, thereby enhancing the reliability and longevity of the converter.

Among the methods discussed for extending voltage gain, the full potential of topology morphing has not been fully exploited. Most prior studies have focused exclusively on the LLC resonant converter, with topology morphing analyses typically confined to the input inverter. In contrast, the CLLC resonant converter incorporates resonant capacitors on both its primary and secondary sides, allowing both inverters to operate in either FB or HB modes.

### SUMMARY

The disclosure is directed to a control method of a CLLC resonant converter, which can ensure balanced power loss and thermal stress, and facilitate smooth transitions between FB-FB, FB-HB, and HB-FB modes.

An embodiment of the disclosure provides a control method of a CLLC resonant converter, wherein the CLLC resonant converter includes a first resonant capacitor and a first FB inverter positioned on a primary side; and a second resonant capacitor and a second FB inverter positioned on a secondary side. Voltages across the first resonant capacitor and the second resonant capacitor are referred to as a first voltage and a second voltage, respectively, and voltages across ac terminals of the first FB inverter and the second FB inverter are referred to as a third voltage and a fourth voltage, respectively. The control method includes: when a first soft-morphing is activated in a HB-FB mode of the operating modes, adjusting the third voltage to adjust the first voltage in transition intervals; when the first soft-morphing is activated in a FB-HB mode of the operating modes, adjusting the fourth voltage to adjust the second voltage in the transition intervals; and when the second soft-morphing is activated between HB-FB and FB-FB modes, adjusting the third voltage and the fourth voltage to increase the first voltage and the second voltage in the transition intervals.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic diagram illustrating the topology of CLLC resonant converters according to an embodiment of the disclosure.

FIG. 1B illustrates the voltage gain curves of CLLC resonant converters under the soft-morphing technique to achieve a continuous 16× ultra-wide voltage gain regulation range according to an embodiment of the disclosure.

FIG. 1C illustrates the four potential operating states of a FB inverter in HB mode, and the rotational operating sequence of conditions “abcd” to achieve a well-balanced power loss and thermal stress among different power switches according to an embodiment of the disclosure.

FIG. 2A illustrates the waveforms of sequence C2B2-A3B3 and its dual sequence C1B1-A2B2 according to an embodiment of the disclosure.

FIG. 2B illustrates the transition sequence B1B2 and B2B1 according to an embodiment of the disclosure.

FIG. 2C illustrates the soft-morphing waveforms of C2B2-A3B3 to C1B1-A2B2 according to an embodiment of the disclosure.

FIG. 2D illustrates the soft-morphing waveforms of C1B1-A2B2 to C2B2-A3B3 according to an embodiment of the disclosure.

FIG. 3A illustrates the waveforms of sequence C1B1-D3B3 and its dual sequence A3B3-D1B1 according to an embodiment of the disclosure.

FIG. 3B illustrates the transition sequence D1D2-B2B1 and D3D2-B2B3 according to an embodiment of the disclosure.

FIG. 3C illustrates the soft-morphing waveforms of C1B1-D3B3 to A3B3-D1B1 according to an embodiment of the disclosure.

FIG. 3D illustrates the soft-morphing waveforms of A3B3-D1B1 to C1B1-D3B3 according to an embodiment of the disclosure.

FIG. 4A illustrates the waveforms of HB-FB sequence C1B1-A2B2 and FB-FB sequence C1C2B2-A3A2B2 according to an embodiment of the disclosure.

FIG. 4B illustrates the transition sequence D1D3-B2B1 according to an embodiment of the disclosure.

FIG. 4C illustrates the soft-morphing waveforms of C1B1-A2B2 to C1C2B2-A3A2B2 according to an embodiment of the disclosure.

FIG. 5A illustrates the waveforms of FB-FB sequence C1B1-A3B3 and FB-HB sequence C1C2B2-D3D2B2 according to an embodiment of the disclosure.

FIG. 5B illustrates the transition sequence D1D3-B1B2 according to an embodiment of the disclosure.

FIG. 5C illustrates the soft-morphing waveforms of C1B1-A3B3 to C1C2B2-D3D2B2 according to an embodiment of the disclosure.

FIG. 6. is a schematic diagram illustrating the operating mode (M, F, d) distribution map of a CLLC resonant converter, including the FB-HB mode, FB-FB mode, and the HB-FB mode according to an embodiment of the disclosure.

FIG. 7. illustrates a state machine soft-morphing synergy control diagram for the CLLC resonant converter according to an embodiment of the disclosure.

FIG. 8 illustrates the experimental waveforms of type1 soft-morphing under HB-FB mode according to an embodiment of the disclosure.

FIG. 9 illustrates the experimental waveforms of type1 soft-morphing under FB-HB mode according to an embodiment of the disclosure.

FIG. 10 illustrates the experimental waveforms of type2 soft-morphing between HB-FB/FB-FB mode according to an embodiment of the disclosure.

FIG. 11 illustrates the experimental waveforms of type2 soft-morphing between FB-FB/FB-HB mode according to an embodiment of the disclosure.

FIG. 12 is a flowchart illustrating a control method of a CLLC resonant converter according to an embodiment of the disclosure.

### DESCRIPTION OF THE EMBODIMENTS

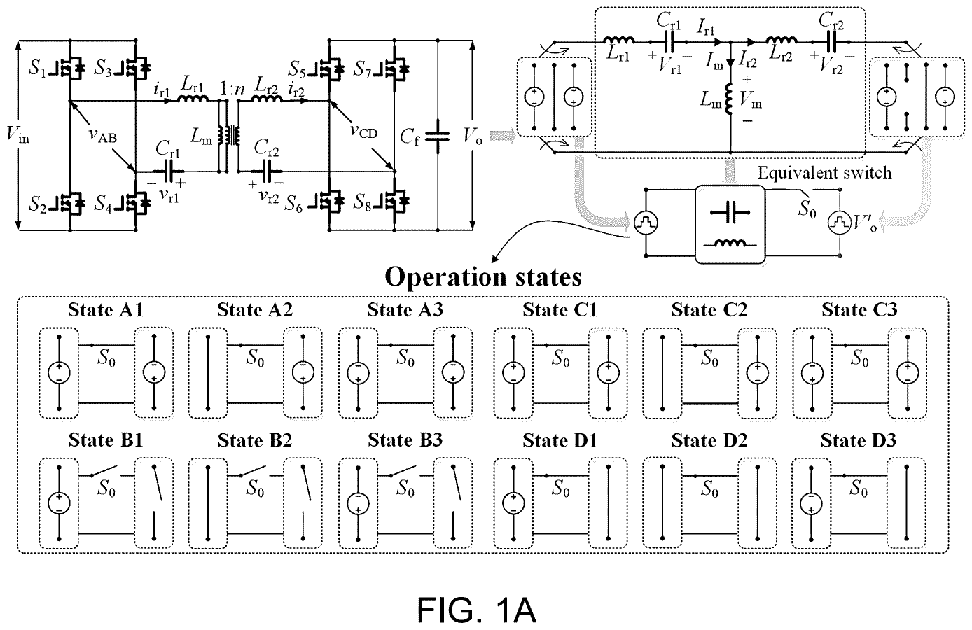

To address the existing problem in the related art, the disclosure investigates the ultra-wide voltage gain characteristics of CLLC resonant converters through the application of soft-morphing techniques. The topology, simplified circuit, and equivalent stages of the CLLC resonant converter of the disclosure are depicted in FIG. 1A. Two forms of soft-morphing are analyzed and developed: type 1, steady-state rotational soft-morphing (first soft-morphing), and type 2, dynamic soft-morphing (second soft-morphing). Steady-state rotational soft-morphing ensures balanced power loss and thermal stress, while dynamic soft-morphing facilitates smooth transitions between FB-FB, FB-HB, and HB-FB modes. According to the method of the disclosure, the FB CLLC resonant converter can achieve an ultra-wide regulation gain of 16×, as shown in FIG. 1B.

Conventionally, the CLLC resonant converter operates solely in either FB or HB modes. Transitioning between these modes often results in high resonant current and voltage spikes due to the hard switching processes involved. These abrupt transitions can induce significant electrical stress on the components, leading to increased wear and potential damage. Moreover, in the related art, the power loss in HB mode is not well-balanced among the power switches. This imbalance causes certain switches to experience higher thermal and electrical stress, ultimately reducing the overall lifespan of the converter.

In the disclosure, the soft-morphing technique is implemented to enhance the performance of the CLLC resonant converter. This technique is divided into two parts:

i) type1, steady-state rotational soft-morphing, this approach ensures balanced power loss and thermal stress across all power switches. By distributing the operational load evenly, it helps prevent localized overheating and extends the lifespan of the converter components.

ii) type2, dynamic soft-morphing, this method facilitates smooth transitions between different operating modes, specifically FB-FB, FB-HB, and HB-FB. By managing these transitions smoothly, it minimizes the occurrence of high resonant current and voltage spikes, thereby reducing electrical stress on the system.

In the disclosure, the FB-FB mode indicates that the CLLC resonant converter operates in the full-bridge (FB) manner on both the primary and secondary sides. The FB-HB mode indicates that the CLLC resonant converter operates in the FB manner on the primary side and in the half-bridge (HB) manner on the secondary side. The HB-FB mode indicates that the CLLC resonant converter operates in the HB manner on the primary side and in the FB manner on the secondary side.

These two types of soft-morphing enable the FB CLLC resonant converter to achieve an ultra-wide voltage gain range of up to 16×. This comprehensive approach not only improves the efficiency and reliability of the converter but also ensures that it can operate effectively across a broader range of voltage levels and load conditions.

Existing methods in the related art have several limitations. They require precise values for all parameters, have a limited voltage gain regulation range, are suitable only for specific topologies, and do not consider power loss and thermal balance of the switches. Additionally, they typically address only steady-state rotational soft-morphing and are suitable only for LLC resonant converters.

In contrast, the disclosure offers several advantages. It balances power loss and thermal stress across all power switches in every operating mode, ensuring more uniform thermal management and longer component lifespan. The disclosure ensures seamless and smooth transitions in both steady-state and dynamic topology morphing, minimizing electrical stress and improving reliability. Furthermore, it maintains high efficiency across an ultra-wide operating range, adapting to varying load conditions without sacrificing performance. Finally, the disclosure expands the potential for continuous voltage gain regulation, offering greater flexibility and adaptability for different applications.

The topology, simplified circuit, and equivalent stages of the CLLC resonant converter of the disclosure are depicted in FIG. 1A. This converter consists of eight power MOSFETs, S₁˜S₈. The resonant inductors Lᵣ₁, Lᵣ₂, along with resonant capacitors Cᵣ₁, Cᵣ₂, are positioned on the primary and secondary sides, respectively. In a symmetric design, the relationship between these resonant components is expressed as Lᵣ₁=n²Lᵣ₂ and Cᵣ₂=n²Cᵣ₁, where n represents the transformer turn ratio. The transformer excitation inductance is denoted as Lₘ, and the inductor ratio is defined as k=Lₘ/Lᵣ₁. Vᵢₙ and Vₒ represent the input and output voltage of the CLLC converter, while the reflected output voltage is given by Vₒ′=Vₒ/n. The voltage gain of the converter is calculated as M=Vₒ′/Vᵢₙ. The primary and secondary resonant currents are indicated by iᵣ₁ and iᵣ₂, respectively, with the excitation current denoted as iₘ. The voltages across Cᵣ₁ and Cᵣ₂ (first resonant capacitor and second resonant capacitor) are referred to as vᵣ₁ (first voltage) and vᵣ₂ (second voltage), respectively. Additionally, the voltages across the ac terminals of the primary and secondary FB inverters (first FB inverter and second FB inverter) are v_{AB} (third voltage) and v_{CD} (fourth voltage), respectively. In some embodiments, the ac terminals serve as the interface between the FB inverters and resonant tanks.

The input and output voltages of the resonant tank exhibit three-level (3L) quasi-square waveforms. The equivalent switch, denoted as S₀, is used to represent the output connection status. Specifically, when S₀=1, v_{CD}=V₀, S₅ and S₈ are tuned-on; When S₀=1, v_{CD}=−V₀, S₆ and S₇ are tuned-on; When S₀=0, S₆˜S₈ are tuned-off. Based on the states of the input and output voltages, the operation of the CLLC resonant converter can be classified into 12 distinct states, labeled from A1 to D3.

Excluding states B1 to B3, all other states conform to the same set of ordinary differential equations (ODEs) with constant coefficients, where

$$\{ \begin{matrix}k ( {I}_{r 1 X}^{′} ( θ ) - {I}_{r 2 X}^{′} ( θ ) ) + {I}_{r 1 X}^{′} ( θ ) + {V}_{r 1 X} ( θ ) = \{ \pm 1 , 0 \} \\ k ( {I}_{r 1 X}^{′} ( θ ) - {I}_{r 2 X}^{′} ( θ ) ) + {I}_{r 2 X}^{′} ( θ ) + {V}_{r 2 X} ( θ ) = \{ \pm M , 0 \} \\ {I}_{r 1 X} ( θ ) = {V}_{r 1 X}^{′} ( θ ) \\ {I}_{r 2 X} ( θ ) = {V}_{r2X}^{′} ( θ )\end{matrix}$$

In these expressions, X represents these states, encompassing state variables such as the primary and secondary resonant currents (Iᵣ₁, Iᵣ₂), the primary and secondary resonant voltages (Vᵣ₁, Vᵣ₂), and the excitation current Iₘ=Iᵣ₁−Iᵣ₂. The general solution is given as

$$[ \begin{matrix}{I}_{r 1 X} ( θ ) \\ {I}_{r 2 X} ( θ ) \\ {I}_{mX} ( θ ) \\ {V}_{r 1 X} ( θ ) \\ {V}_{r 2 X} ( θ )\end{matrix} ] = [ \begin{matrix}\frac{{c}_{1 X} + {c}_{2 X}}{2} & - \frac{{c}_{3 X} + {c}_{4 X}}{2} & \frac{{c}_{1 X} - {c}_{2 X}}{2} & \frac{{k}_{1} ( {c}_{4 X} - {c}_{3 X} )}{2} \\ \frac{{c}_{1 X} + {c}_{2 X}}{2} & - \frac{{c}_{3 X} + {c}_{4 X}}{2} & \frac{{c}_{2 X} - {c}_{1 X}}{2} & \frac{{k}_{1} ( {c}_{3 X} - {c}_{4 X} )}{2} \\ 0 & 0 & \frac{{c}_{1 X} - {c}_{2 X}}{2} & - \frac{{k}_{1} ( {c}_{3 X} + {c}_{4 X} )}{2} \\ \frac{{c}_{3 X} + {c}_{4 X}}{2} & \frac{{c}_{1 X} + {c}_{2 X}}{2} & \frac{{k}_{1} ( {c}_{3 X} - {c}_{4 X} )}{2} & \frac{{c}_{1 X} - {c}_{2 X}}{2 {k}_{i}} \\ \frac{{c}_{3 X} + {c}_{4 X}}{2} & \frac{{c}_{1 X} + {c}_{2 X}}{2} & \frac{{k}_{1} ( {c}_{4 X} - {c}_{3 X} )}{2} & \frac{{c}_{2 X} - {c}_{1 X}}{2 {k}_{i}}\end{matrix} ] [ \text{} \begin{matrix}cos ( θ ) \\ sin ( θ ) \\ cos ( {k}_{1} θ ) \\ sin ( {k}_{1} θ )\end{matrix} ] + [ \begin{matrix}0 \\ 0 \\ 0 \\ \{ \pm 1 , 0 \} \\ \{ ∓ M , 0 \}\end{matrix} ]$$

States B1/B2/B3 are distinct from other states due to the output side forming an open circuit, leading to only one resonant frequency within the resonant tank. The general solutions for these states are outlined as follows

$$[ \begin{matrix}{I}_{r 1 Y} ( θ ) \\ {I}_{r 2 Y} ( θ ) \\ {I}_{mY} ( θ ) \\ {V}_{r 1 Y} ( θ ) \\ {V}_{r 2 Y} ( θ )\end{matrix} ] = [ \begin{matrix}{c}_{1 Y} & - {c}_{2 Y} \\ 0 & 0 \\ {c}_{1 Y} & - {c}_{2 Y} \\ {c}_{2 Y} & - {c}_{1 Y} \\ 0 & 0\end{matrix} ] [ \begin{matrix}cos ( {k}_{2} θ ) \\ sin ( {k}_{2} θ )\end{matrix} ] + [ \begin{matrix}0 \\ 0 \\ 0 \\ \{ \pm 1 , 0 \} \\ {V}_{r 2 Y} ( 0 )\end{matrix} ]$$

According to the stage equations, the operation characteristic of the converter can be calculated.

The type1 steady-state rotational soft-morphing is necessary in both HB-FB and FB-HB modes. FIG. 1C illustrates the four potential operating states in HB modes of a FB inverter. Conditions a and b are characterized by a positive DC bias resonant voltage, whereas conditions c and d exhibit a negative DC bias resonant voltage. To ensure balanced power loss and thermal stress, these states should follow a rotational sequence of ‘abcd’. Transitions between conditions a/b and c/d are naturally seamless due to the consistent DC bias resonant voltage. However, transitions between conditions d/a and b/c necessitate a typical sequence for altering the voltage bias v_{AB}, v_{CD}. FIG. 1C is based on the primary side of FB in HB mode, for example. The rotational sequence can also be implemented based on the secondary side of FB in HB mode.

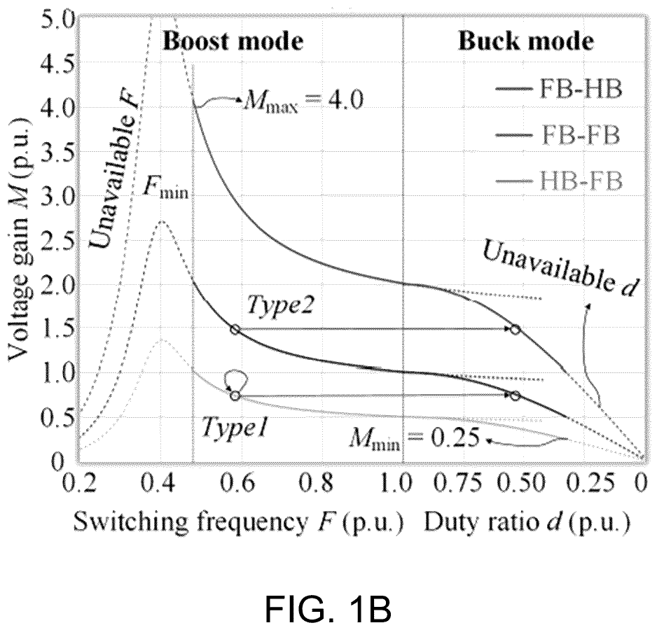

In HB-FB mode, it is necessary to manipulate the transition sequence to adjust the dc bias of Vᵣ₁ while preserving the other resonant parameters (Iᵣ₁, Iᵣ₂, Iₘ, and Vᵣ₂) constant, i.e. less volatility (less than 0.5 p.u.). It means that the transition sequence works by changing only the DC bias voltage of Vᵣ₁ while leaving the other resonant parameters unchanged. It is important to note that the steady state operations in both boost and buck modes conclude with Iᵣ₁=Iᵣ₂, and Iₘ=0. Therefore, it is evident that employing the state combination B1/B2/B3 facilitates the shift in the dc bias of Vᵣ₁. The effectiveness of the transition sequence is demonstrated through the HB-FB sequence C2B2-A3B3 and its dual sequence C1B1-A2B2, which are illustrated in FIG. 2A and FIG. 2B. In the sequence C2B2-A3B3, V_{AB} comprises (−1, 0), inducing a negative dc bias on Vᵣ₁. Conversely, in the dual sequence C1B1-A2B2, V_{AB} comprises (1, 0), resulting in a positive dc bias on Vᵣ₁. A transition sequence, B1B2, is employed to increase the dc bias on Vᵣ₁. Similarly, to decrease the dc bias voltage of Vᵣ₁ while preserving all other electrical characteristics, the transition sequence is altered from “B1B2” to “B2B1”. Following these transition sequences, the soft-morphing waveforms between C2B2-A3B3 and C1B1-A2B2 are illustrated at FIG. 2C and FIG. 2D.

To be specific, referring to FIG. 2C (soft-morphing: C2B2-A3B3 to C1B1-A2B2), for transitions between conditions d/a, on the left side of the transition interval θ_{B1}, V_{AB} of the sequence C2B2-A3B3 is 0, and the dc bias voltage of Vᵣ₁ increases to close to 0. On the right side of the transition interval θ_{B2}, V_{AB} of the sequence C1B1-A2B2 is 0, and the dc bias voltage of Vᵣ₁ increases to close to 1. In the transition intervals θ_{B1} and θ_{B2}, V_{AB} is controlled so that the dc bias voltage of Vᵣ₁ continues to increase. The transition intervals θ_{B1} and θ_{B2} include states B1 and B2. In state B1, the equivalent switch on the primary side is on to set V_{AB} as Vdc, and the equivalent switch S₀ between the primary and secondary sides is off. In state B2, the equivalent switch on the primary side is shorted to set V_{AB} as 0, and the equivalent switch S₀ between the primary and secondary sides is off. Therefore, the dc bias voltage of Vᵣ₁ continues to increase.

On the other hand, referring to FIG. 2D (soft-morphing: C1B1-A2B2 to C2B2-A3B3), for transitions between conditions b/c, on the left side of the transition interval θ_{B2}, V_{AB} of the sequence C1B1-A2B2 is 1, and the dc bias voltage of Vᵣ₁ start to decrease from 1. On the right side of the transition interval θ_{B1}, V_{AB} of the sequence C2B2-A3B3 is −1, and the dc bias voltage of Vᵣ₁ decreases to close to −1. In the transition intervals θ_{B2} and θ_{B1}, V_{AB} is controlled so that the dc bias voltage of Vᵣ₁ continues to decrease. The transition intervals θ_{B1} and θ_{B2} include states B2 and B1. In state B2, the equivalent switch on the primary side is shorted to set V_{AB} as 0, and the equivalent switch S₀ between the primary and secondary sides is off. In state B1, the equivalent switch on the primary side is positively on to set V_{AB} as Vdc, and the equivalent switch S₀ between the primary and secondary sides is off. Therefore, the dc bias voltage of Vᵣ₁ continues to decrease.

Therefore, when the type 1 steady-state rotational soft-morphing is performed in HB-FB mode, V_{AB} is switched to make the dc bias voltage of Vᵣ₁ smoothly change.

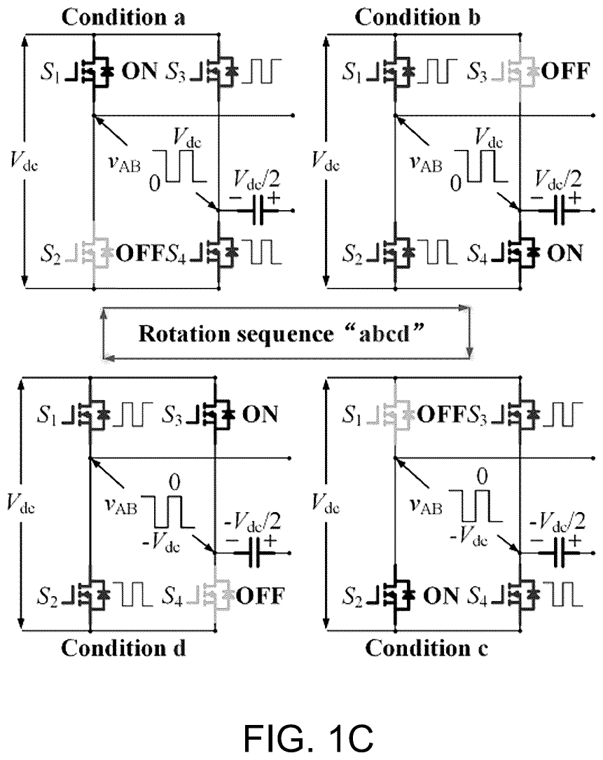

In FB-HB mode, the transition sequence is essential for adjusting the dc bias of Vᵣ₂ while preserving the other resonant parameters (Iᵣ₁, Iᵣ₂, Iₘ, and Vᵣ₁) unchanged. It means that the final values of the other resonant parameters before the transition sequence are the same as the initial values of the other resonant parameters after the transition sequence. Unlike in HB-FB mode, where the dc bias of Vᵣ₁ remains constant, the states B1/B2/B3 alone are insufficient to modify Vᵣ₂. Therefore, to increase the dc bias of Vᵣ₂, the transition sequence D1D2-B2B1 is employed, and to decrease it, the sequence D3D2-B2B3 is utilized. To demonstrate the function of the transition sequence in FB-HB mode, the sequence C1B1-D3B3 and its dual sequence A3B3-D1B1 are utilized, with their corresponding waveforms illustrated in FIG. 3A and FIG. 3B. In the sequence C1B1-D3B3, V_{CD} exhibits values of (−M, 0), resulting in a positive de bias on Vᵣ₂. Conversely, in the dual sequence A3B3-D1B1, V_{CD} shows values of (M, 0), leading to a negative dc bias on Vᵣ₂. Additionally, by altering the sequence of states, the dual transition sequence that results in a reduction of Vᵣ₂ can also be established. The soft-morphing waveforms corresponding to these transitions are depicted at FIG. 3C and FIG. 3D.

To be specific, referring to FIG. 3C (soft-morphing: C1B1-D3B3 to A3B3-D1B1), on the left side of the transition interval θ_{D1}, V_{CD} of the sequence C1B1-D3B3 is changed between negative voltages to 0, and the dc bias voltage of Vᵣ₂ is positive. On the right side of the transition interval θ_{B1}, V_{CD} of the sequence A3B3-D1B1 is changed between 0 to positive voltages, and the dc bias voltage of Vᵣ₂ is negative. In the transition intervals θ_{D1}, θ_{D2}, θ_{B2}, and θ_{B1}, V_{CD} is controlled so that the dc bias voltage of Vᵣ₂ continues to decrease. The transition intervals include decreasing intervals θ_{D1} and θ_{D2} and steady intervals θ_{B2} and θ_{B1}. In the decreasing intervals θ_{D1} and θ_{D2}, the equivalent switch on the secondary side is shorted, and V_{CD} is set as 0. Therefore, the de bias voltage of Vᵣ₂ continues to decrease. In the steady intervals θ_{B2} and θ_{B1}, the equivalent switch on the secondary side is off, and V_{CD} is set to change between −3 and 0.

On the other hand, referring to FIG. 3D (soft-morphing: A3B3-D1B1 to C1B1-D3B3), on the left side of the transition interval θ_{D3}, V_{CD} of the sequence A3B3-D1B1 is changed between 0 to positive voltages, and the de bias voltage of Vᵣ₂ is negative. On the right side of the transition interval θ_{B3}, V_{CD} of the sequence C1B1-D3B3 is changed between negative voltages to 0, and the dc bias voltage of Vᵣ₂ is positive. In the transition intervals θ_{D3}, θ_{D2}, θ_{B2}, and θ_{B3}, V_{CD} is controlled so that the de bias voltage of Vᵣ₂ continues to increase. The transition intervals include increasing intervals θ_{D3} and θ_{D2} and steady intervals θ_{B2} and θ_{B3}. In the increasing intervals θ_{D3} and θ_{D2}, the equivalent switch on the secondary side is shorted, and V_{CD} is set as 0. Therefore, the de bias voltage of Vᵣ₂ continues to increase. In the steady intervals θ_{B2} and θ_{B3}, the equivalent switch on the secondary side is off, and V_{CD} is set to change between 0 and 3.

Therefore, when the type1 steady-state rotational soft-morphing is performed in FB-HB mode, V_{CD} is switched to make the dc bias voltage of Vᵣ₂ smoothly change.

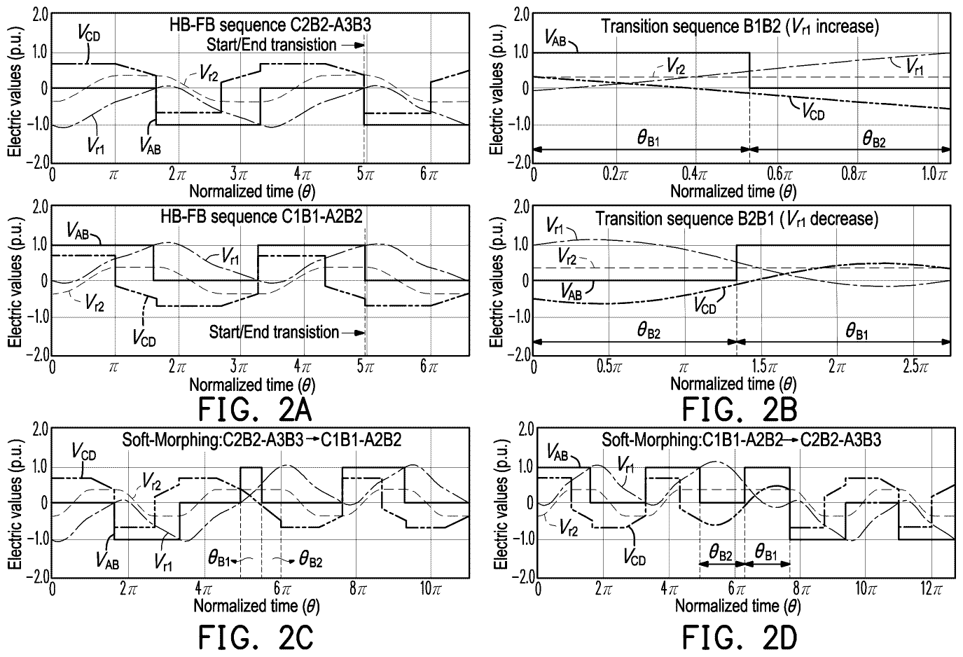

The dynamic soft-morphing between HB-FB and FB-FB modes occurs when the voltage gain is within the range of [0.25, 1.0]. In the overlapping regions between HB-FB and FB-FB modes, the former operates in boost mode while the latter operates in buck mode. In this scenario, the typical transition sequence between HB-FB and FB-FB modes is D1D3-B2B1. States D1D3 are employed to increase the values of Vᵣ₁ and Vᵣ₂, while states B2B1 are used to align the end values of the state variables with those in the other mode. Finally, the dynamic soft-morphing transition from C1B1-A2B2 to C1C2B2-A3A2B2 is achieved, with the corresponding waveforms depicted in FIG. 4A, FIG. 4B, and FIG. 4C.

To be specific, referring to FIG. 4C (soft-morphing: C1B1-A2B2 to C1C2B2-A3A2B2), the dynamic soft-morphing is activated from the HB-FB mode to the FB-FB mode. On the left side of the transition interval θ_{D1}, the dc bias voltages of Vᵣ₁ and Vᵣ₂ locate at a relatively low region of HB-FB mode transition interval, and the dc bias voltage of Vᵣ₂ is negative. On the right side of the transition interval θ_{B1}, the dc bias voltages of Vᵣ₁ and Vᵣ₂ locate at a relatively high region of FB-FB mode transition interval, and the de bias voltage of Vᵣ₂ is positive. The transition intervals include increasing intervals θ_{D1} and θ_{D3} and steady intervals θ_{B2} and θ_{B1}. In the increasing intervals θ_{D1} and θ_{D3}, the dc bias voltages of Vᵣ₁ and Vᵣ₂ increase. In the steady intervals θ_{B2} and θ_{B1}, the dc bias voltage Vᵣ₂ remains unchanged.

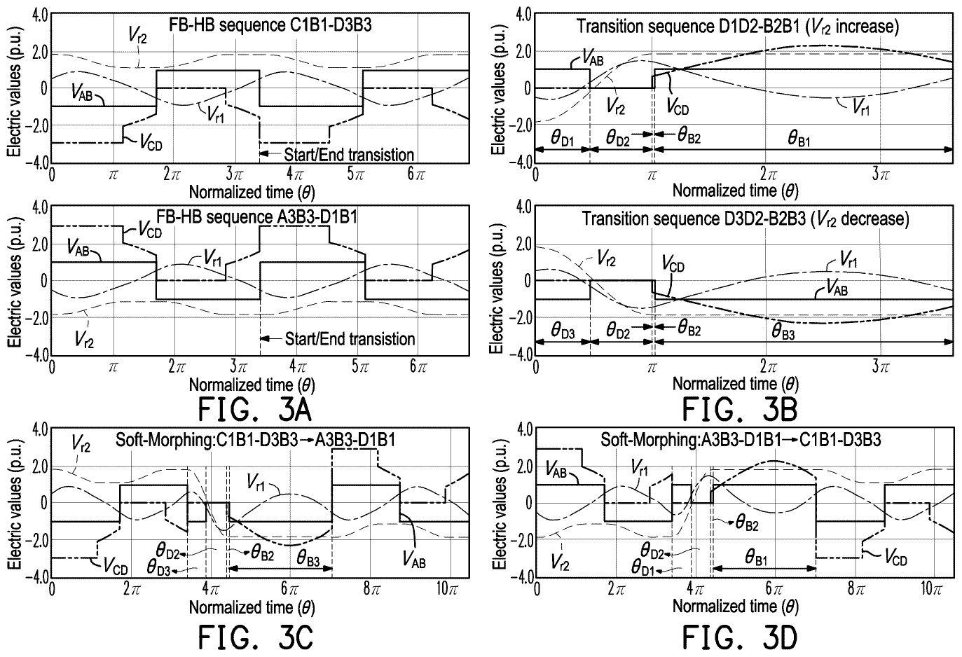

The dynamic soft-morphing between FB-FB and FB-HB modes occurs when the voltage gain is within the range of [1.0, 4.0]. In the regions where FB-FB and FB-HB modes overlap, the FB-FB mode operates in boost mode, while the FB-HB mode operates in buck mode. The transition sequence between FB-FB and FB-HB modes is D1D3-B1B2. The waveforms for the FB-FB sequence C1B1-A3B3, and FB-HB sequence C1C2B2-D3D2B2, along with their soft-morphing waveforms, are depicted in FIG. 5A, FIG. 5B, and FIG. 5C.

To be specific, referring to FIG. 5C (soft-morphing: C1B1-A3B3 to C1C2B2-D3D2B2), the dynamic soft-morphing is activated from the FB-FB mode to the FB-HB mode. On the left side of the transition interval θ_{D1}, the dc bias voltages of Vᵣ₁ and Vᵣ₂ locate at a relatively low region of FB-FB mode transition interval, and the dc bias voltage of Vᵣ₂ is negative. On the right side of the transition interval θ_{B2}, the dc bias voltages of Vᵣ₁ and Vᵣ₂ locate at a relatively high region of FB-HB mode transition interval, and the dc bias voltage of Vᵣ₂ is positive. The transition intervals include increasing intervals θ_{D1} and θ_{D3} and steady intervals θ_{B1} and θ_{B2}. In the increasing intervals θ_{D1} and θ_{D3}, the dc bias voltages of Vᵣ₁ and Vᵣ₂ increase. In the steady intervals θ_{B1} and θ_{B2}, the dc bias voltage of Vᵣ₂ remains unchanged.

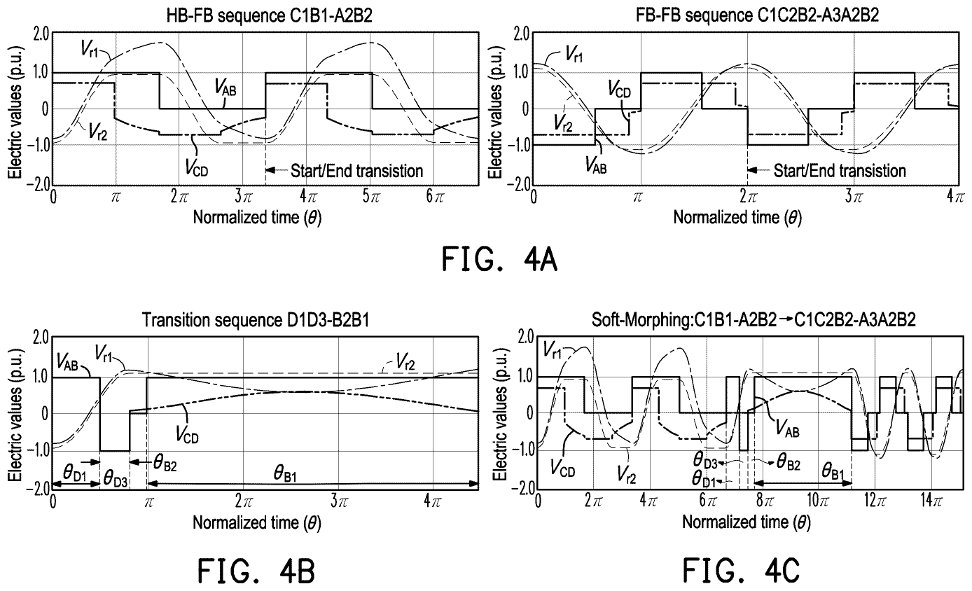

In summary, type1 soft-morphing is essential in both HB-FB and FB-HB modes, whereas type2 soft-morphing becomes necessary when adjusting the voltage gain at the transitions between HB-FB/FB-FB and FB-FB/FB-HB modes. As for a specific CLLC resonant converter, it is requisite that each mode maintains a certain range of voltage gain regulation. The typical operating mode distribution map, characterized by (M, F, d), is illustrated in FIG. 6. Across all operational modes, the values of switching frequency F and d are within the ranges FE [0.6, 1.2], and de [0.6, 1.0], wherein d represents the duty cycle. In FB-FB mode, d represents the duty cycle of the primary side full bridge. In FB-HB mode, d is the duty cycle of the primary side full bridge. In HB-FB mode, d represents the duty cycle of the secondary side full bridge.

In FB-HB mode, there is M_{T}=2.0, achieved with F=1.0, d=1.0. M_{T} is the voltage gain due to mode switching. In FB-FB mode, Mt=1.0. In FB-HB mode, M_{T}=2.0. In HB-FB mode, M_{T}=0.5. In boost mode, reducing F elevates M to a maximum of Mₘₐₓ=4.0. At any operational point in this mode, type1 soft-morphing is necessitated. Similarly, in FB-FB mode, there is M_{T}=1.0. In boost mode, it is crucial to ensure that the Mₘₐₓ>1.5 under the heaviest load conditions, facilitating type2 soft-morphing transitions between FB-HB/FB-FB modes. The HB-FB mode differs from the others as the input is a half-bridge inverter, and a 3L operation is not feasible. Consequently, PFM is employed in boost and buck modes. The minimum voltage gain, Mₘᵢₙ is achieved at the lightest load, with F=1.2, P=0.1.

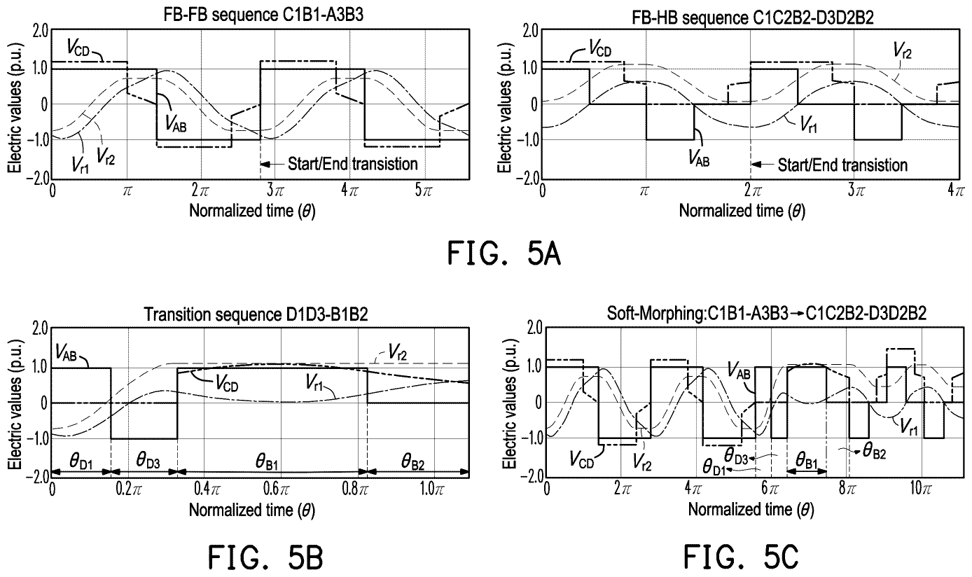

Integrating the aforementioned analysis, the state machine soft-morphing synergy control diagram for the CLLC resonant converter is illustrated in FIG. 7. This control method operates in every switching cycle, categorized into five states and seven actions. In both FB-HB and HB-FB modes, when the count of switching cycles in type1 soft-morphing is equal to a predefined threshold, type1 soft-morphing action is activated, and the counter is reset. Upon achieving the voltage gain at the designated boundary, type2 soft-morphing is activated to facilitate transitions between operating modes.

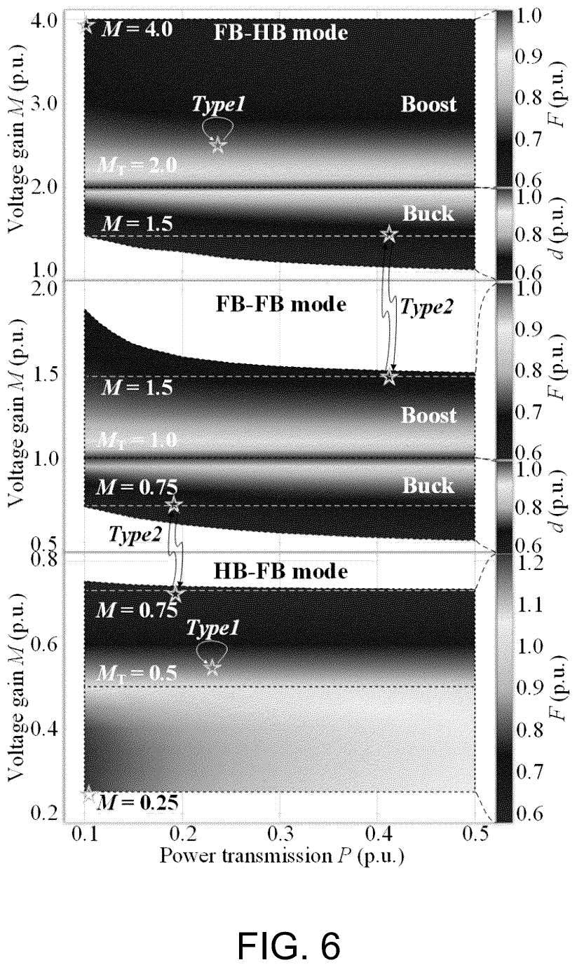

To verify the analysis, an experimental CLLC resonant converter prototype was built, and the experimental waveforms are shown in FIG. 8 to FIG. 11. Under type1 soft-morphing conditions, a fixed N=100 switching cycles between transitions is selected. It should be noted that N can be adjusted based on converter requirements. As different operating modes are interchanged, a low-frequency component will be induced. Generally, a larger N reduces the frequency of these low-frequency components but increases the power MOSFET junction thermal swing. When N is sufficiently large, the low-frequency electromagnetic interface (EMI) effect can be neglected.

In type1 soft-morphing under HB-FB mode, the input voltage is 240 V and the output power is 0.9 kW. The experimental waveforms are shown in FIG. 8. The input inverter bridge alternated between two modes, while the output inverter bridge operated continuously. In this scenario, the four primary power MOSFETs, S₁˜S₄ followed a repeating sequence of “HF, 0, HF, 1” resulting in a 3L waveform for V_{AB}. The zoomed waveforms reveal that the primary switch gate driver waveforms maintain a full duty cycle. During the rotational soft-morphing transition, the waveforms remained smooth without current spikes.

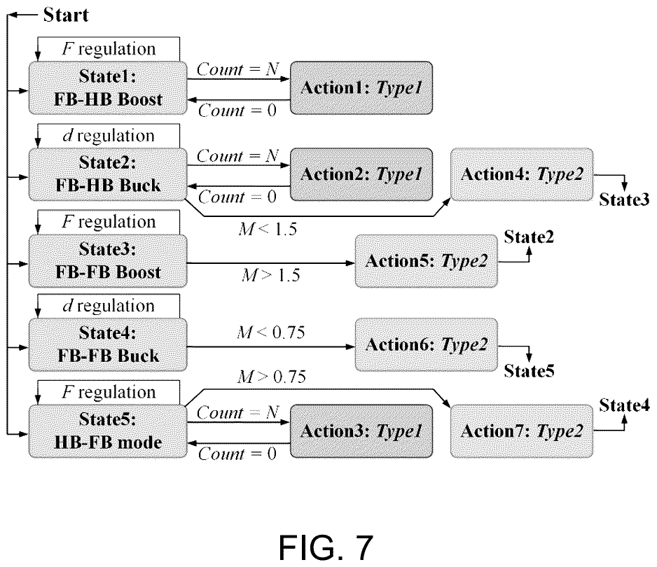

In type1 soft-morphing under FB-HB mode, the input voltage is 120 V and the output power is 1.8 kW. The experimental waveforms are shown in FIG. 9. In this scenario, the output inverter bridge alternated between two modes, while the input inverter bridge operated continuously. Hence, V_{CD} exhibited a 3L waveform. The four secondary power MOSFETs, S₅˜S₈, followed a repeating sequence of “HF, 0, HF, 1”. The zoomed waveforms reveal that the secondary switch gate driver waveforms maintain a reduced duty cycle. During the transition process, there exists current spike in iᵣ₂, while the current spike in iᵣ₁ is small.

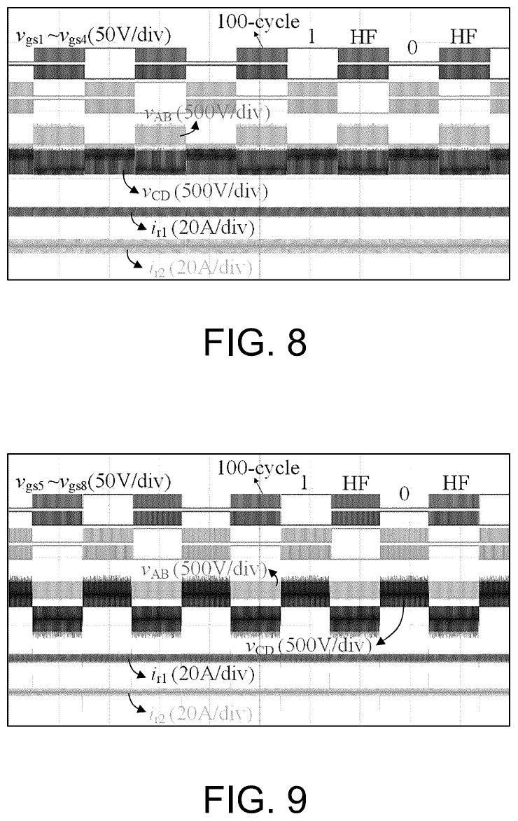

The type2 dynamic soft-morphing occurs at the boundaries of HB-FB/FB-FB modes and FB-FB/FB-HB modes, with their corresponding voltage gain transition points at M=0.75, and M=1.5, respectively. In FIG. 10, the voltage gain reference, M_{ref} is increased using a predefined ramp, and an operating mode flag is employed to illustrate the dynamic soft-morphing transition process. Initially, there is M_{ref}=0.5. Since this operating condition is in HB-FB mode, type1 soft-morphing with N=100 is utilized. Consequently V_{AB} and vᵣ₁ are 3L waveforms. When the voltage gain is equal to M=0.75, the converter switches to FB-FB mode with type2 soft-morphing. The zoomed waveform shows a seamless transition without any voltage or current spikes.

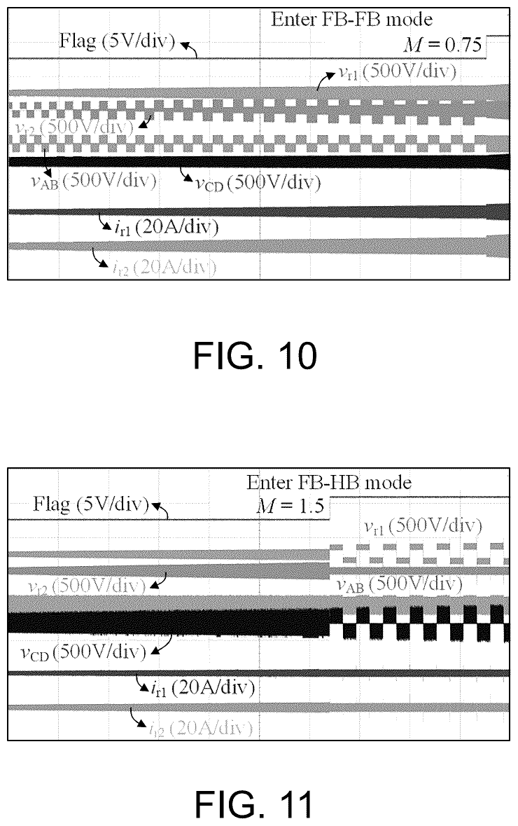

Similarly, in FIG. 11, M_{ref} is increased from 1.0 using a predefined ramp. Initially, the operating condition is in FB-FB mode. When the voltage gain is equal to M=1.5, the converter transitions to FB-HB mode with type2 soft-morphing. This transition is also seamless, without any voltage or current spikes. Subsequently, type1 soft-morphing with N=100 is employed, resulting in 3L waveforms of v_{CD} and vᵣ₂. From the above waveforms, it is evident that both types of soft-morphing are effectively implemented to expand the voltage gain range.

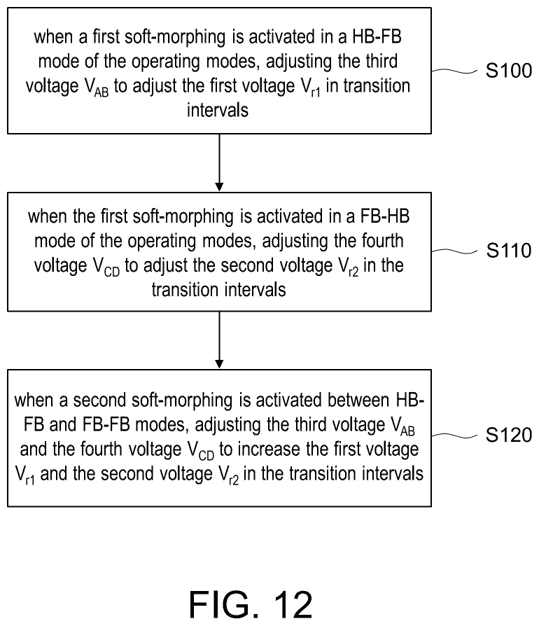

FIG. 12 is a flowchart illustrating a control method of a CLLC resonant converter according to an embodiment of the disclosure. Referring to FIG. 1A and FIG. 12, the control method is at least adapted to the CLLC resonant converter of FIG. 1A, but the disclosure is not limited thereto.

Taking the CLLC resonant converter of FIG. 1A for example, in step S100, when the first soft-morphing is activated in the HB-FB mode, the third voltage V_{AB} is adjusted to adjust the first voltage Vᵣ₁ in transition intervals. In step S110, when the first soft-morphing is activated in the FB-HB mode, the fourth voltage V_{CD} is adjusted to adjust the second voltage Vᵣ₂ in the transition intervals. In step S120, when the second soft-morphing is activated between the HB-FB and FB-FB modes, the third voltage V_{AB} and the fourth voltage V_{CD} are adjusted to increase the first voltage Vᵣ₁ and the second voltage Vᵣ₂ in the transition intervals.

The control method described in the embodiment of the disclosure is sufficiently taught, suggested, and embodied in the embodiments illustrated in FIG. 1A to FIG. 11, and therefore no further description is provided herein.

The control method of FIG. 12 may be performed by a controller. The controller may be designed through hardware description languages (HDL) or any other design methods for digital circuits familiar to people skilled in the art and may be hardware circuits implemented through a field programmable gate array (FPGA), a complex programmable logic device (CPLD), or an application-specific integrated circuit (ASIC). Alternatively, the controller may be a processor having computational capability.

In summary, in the embodiment of the disclosure, the control method effectively facilitates seamless soft-morphing between different operating modes while maintaining well-balanced power loss across various power switches. This balanced distribution of power loss helps to prevent overheating and extends the lifespan of the converter components. Additionally, the control method of the disclosure achieves an ultra-flat efficiency curve, indicating consistently high efficiency across a wide range of operating scenarios. This robustness in performance ensures reliable and efficient operation, making the control method of the disclosure suitable for diverse applications requiring flexible and efficient power conversion.

The disclosure can be at least applied to resonant converters with wide output voltage regulation conditions, including EV charging stations, renewable energy systems (solar and wind power), data centers and telecommunications (uninterruptible power supplies and power distribution units), industrial power supplies (high-precision equipment, motor drives, automation), consumer electronics (adaptive power adapters, battery chargers), and healthcare equipment (medical imaging devices, portable medical devices). The above-mentioned applications are not intended to limit the disclosure.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A control method of a CLLC resonant converter, wherein the CLLC resonant converter comprises a first resonant capacitor and a first FB inverter positioned on a primary side; and a second resonant capacitor and a second FB inverter positioned on a secondary side, wherein voltages across the first resonant capacitor and the second resonant capacitor are referred to as a first voltage and a second voltage, respectively, and voltages across ac terminals of the first FB inverter and the second FB inverter are referred to as a third voltage and a fourth voltage, respectively, the control method comprising:
when a first soft-morphing is activated in a HB-FB mode of the operating modes, adjusting the third voltage to adjust the first voltage in transition intervals;
when the first soft-morphing is activated in a FB-HB mode of the operating modes, adjusting the fourth voltage to adjust the second voltage in the transition intervals; and
when a second soft-morphing is activated between HB-FB and FB-FB modes, adjusting the third voltage and the fourth voltage to increase the first voltage and the second voltage in the transition intervals.

2. The control method of the CLLC resonant converter according to claim 1, wherein the step of adjusting the third voltage to adjusting the first voltage in the transition intervals comprises:
when the first soft-morphing from a first sequence to a second sequence is activated in the HB-FB mode, adjusting the third voltage to increase the first voltage in the transition intervals; and
when the first soft-morphing from the second sequence to the first sequence is activated in the HB-FB mode, adjusting the third voltage to decrease the first voltage in the transition intervals.

3. The control method of the CLLC resonant converter according to claim 2, wherein the transition intervals include a first transition interval and a second transition interval, and the control method further comprises:
setting the third voltage as an input voltage of the CLLC resonant converter in the first transition interval; and
setting the third voltage as zero in the second transition interval.

4. The control method of the CLLC resonant converter according to claim 3, wherein in the first transition interval, an equivalent switch on the primary side is positively on, and an equivalent switch between the primary and secondary sides is off.

5. The control method of the CLLC resonant converter according to claim 3, wherein in the second transition interval, an equivalent switch on the primary side is shorted, and an equivalent switch between the primary and secondary sides is off.

6. The control method of the CLLC resonant converter according to claim 1, wherein the step of adjusting the fourth voltage to adjust the second voltage in the transition intervals comprises:
when the first soft-morphing from a third sequence to a fourth sequence is activated in the FB-HB mode, adjusting the fourth voltage to decrease the second voltage in the transition intervals; and
when the first soft-morphing from the fourth sequence to the third sequence is activated in the FB-HB mode, adjusting the fourth voltage to increase the second voltage in the transition intervals.

7. The control method of the CLLC resonant converter according to claim 6, wherein the transition intervals include decreasing intervals and steady intervals, and the control method further comprises:
setting the fourth voltage as zero in the decreasing intervals.

8. The control method of the CLLC resonant converter according to claim 7, wherein in the decreasing intervals, an equivalent switch on the secondary side is shorted.

9. The control method of the CLLC resonant converter according to claim 7, wherein in the steady intervals, the equivalent switch on the secondary side is off.

10. The control method of the CLLC resonant converter according to claim 6, wherein the transition intervals include increasing intervals and steady intervals, and the control method further comprises:
setting the fourth voltage as zero in the increasing intervals.

11. The control method of the CLLC resonant converter according to claim 10, wherein in the increasing intervals, the equivalent switch on the secondary side is shorted.

12. The control method of the CLLC resonant converter according to claim 10, wherein in the steady intervals, the equivalent switch on the secondary side is off.

13. The control method of the CLLC resonant converter according to claim 1, wherein the transition intervals include increasing intervals and steady intervals, the step of adjusting the third voltage and the fourth voltage to increase the first voltage and the second voltage in the transition intervals further comprises:
when the second soft-morphing is activated from the FB-FB mode to the FB-HB mode, adjusting the third voltage and the fourth voltage to increase the first voltage and the second voltage in the increasing intervals; and
when the second soft-morphing is activated from the HB-FB mode to the FB-FB mode, adjusting the third voltage and the fourth voltage to increase the first voltage and the second voltage in the increasing intervals.

14. The control method of the CLLC resonant converter according to claim 13, wherein in the steady intervals, the second voltage remains unchanged.

15. The control method of the CLLC resonant converter according to claim 1, wherein the control method operates in switching cycles, the control method further comprising:
activating the first soft-morphing when a count of the switching cycles is equal to a predefined threshold; and
activating the second soft-morphing to control transitions between operating modes of the CLLC resonant converter according to a voltage gain.

16. The control method of the CLLC resonant converter according to claim 15, wherein the first soft-morphing is activated in a FB-HB mode or a HB-FB mode of the operating modes when the count of the switching cycles is equal to the predefined threshold.

17. The control method of the CLLC resonant converter according to claim 16, wherein the first soft-morphing is activated in a boost mode or a buck mode of the FB-HB mode when the count of the switching cycles is equal to the predefined threshold.

18. The control method of the CLLC resonant converter according to claim 16, further comprising:
in the HB-FB mode, controlling a transition sequence to adjust the first voltage.

19. The control method of the CLLC resonant converter according to claim 18, further comprising:
maintaining a primary resonant current, a secondary resonant current, an excitation current, and the second voltage of the CLLC resonant converter constant.

20. The control method of the CLLC resonant converter according to claim 16, further comprising:
in the FB-HB mode, controlling a transition sequence to adjust the second voltage.

21. The control method of the CLLC resonant converter according to claim 20, further comprising:
maintaining a primary resonant current, a secondary resonant current, an excitation current, and the first voltage of the CLLC resonant converter constant.

22. The control method of the CLLC resonant converter according to claim 15, further comprising:
resetting the count of the switching cycles after the first soft-morphing is activated.

23. The control method of the CLLC resonant converter according to claim 15, wherein the second soft-morphing is activated at a first boundary of a HB-FB mode and a FB-FB mode or at a second boundary of the FB-FB mode and a FB-HB mode.

24. The control method of the CLLC resonant converter according to claim 23, wherein the voltage gain is set to have different threshold values for the first boundary and the second boundary.

25. The control method of the CLLC resonant converter according to claim 24, wherein a first threshold value set for the voltage gain of the first boundary is smaller than a second threshold value set for the voltage gain of the second boundary.

26. The control method of the CLLC resonant converter according to claim 23, wherein the CLLC resonant converter transitions from the FB-FB mode to the HB-FB mode with the second soft-morphing when the voltage gain is smaller than a first threshold value.

27. The control method of the CLLC resonant converter according to claim 26, wherein the CLLC resonant converter transitions from the HB-FB mode to the FB-FB mode with the second soft-morphing when the voltage gain is larger than or equal to the first threshold value.

28. The control method of the CLLC resonant converter according to claim 23, wherein the CLLC resonant converter transitions from the FB-FB mode to the FB-HB mode with the second soft-morphing when the voltage gain is larger than or equal to a second threshold value.

29. The control method of the CLLC resonant converter according to claim 28, wherein the CLLC resonant converter transitions from the FB-HB mode to the FB-FB mode with the second soft-morphing when the voltage gain is smaller than the second threshold value.

30. The control method of the CLLC resonant converter according to claim 23, wherein the second soft-morphing between the HB-FB mode and the FB-FB mode is activated when the voltage gain is within a first range.

31. The control method of the CLLC resonant converter according to claim 30, wherein the second soft-morphing between the FB-FB mode and the FB-HB mode is activated when the voltage gain is within a second range different from the first range.

32. The control method of the CLLC resonant converter according to claim 31, wherein the second range is larger than the first range.

33. The control method of the CLLC resonant converter according to claim 15, wherein the first soft-morphing is a steady-state rotational soft-morphing, and the second soft-morphing is a dynamic soft-morphing.

34. The control method of the CLLC resonant converter according to claim 15, wherein the count of the switching cycles is adjusted to reduce a frequency of low-frequency components of the CLLC resonant converter and increase a junction thermal swing of transistor devices of the CLLC resonant converter.
